(19) United States
(12) Patent Application Publication
(10) Pub. No.: US 2006/0117100 A1
(43) Pub. Date: Jun. 1, 2006

(54) Communication device and communication system capable of facilitating operations

(76) Inventors: Yukio Ogawa, Tokyo (JP); Yuji Kimura, Kawasaki (JP); Toshikazu Yasue, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/139,495

(22) Filed: May 31, 2005

(30) Foreign Application Priority Data
Nov. 16, 2004 (JP) 2004-331335

(51) Int. Cl. G06F 15/173

(52) U.S. Cl. 709/223

(57) ABSTRACT

A communication system enables even an operator other than experts to correctly perform operations for a communication device such as an operation for modifying the configuration of the communication device without fail through simple operations without taking a long time for the operations, and permits the operator to keep track of the status of the operation in a remote management server. The communication device acquires an operational scenario from a management server, assigns the execution of the operational scenario to an operation input unit, and executes the operational scenario in response to an instruction which is issued from the operator by depressing an associated button on the input unit. The communication device displays the result of the execution on a display unit, and notifies the management server of the result.

### INCORPORATION BY REFERENCE

The present application claims priority from Japanese application JP 2004-331335 filed on Nov. 16, 2004, the content of which is hereby incorporated by reference into this application.

### BACKGROUND OF THE INVENTION

The present invention relates to techniques for facilitating operations of a communication device by controlling the communication device from a management server through a communication network.

In a communication network, a communication device for transferring communication data implies such problems as a long time taken for its operations due to complicated sequences of operations, and difficulties in operations for operators other than experts. While some communication devices have a web-based configuration interface, the foregoing problems remain unsolved because such an interface can facilitate accesses to the communication device but does not simplify the operations themselves.

To address the foregoing problems, a communication device described, for example, in JP-A-2004-265174 provides an interactive operation environment for operators. Specifically, the communication device executes an operational scenario, which is described while receiving instructions entered therein, to select and execute a communication application, thereby alleviating an operational burden on the operator.

In a management system described in JP-A-2001-109686, a communication device acquires an operational scenario, which describes details of operations performed thereon, from a management server to executes addition, deletion and the like of managed items, thereby alleviating an operational burden on the communication device.

In order for an operator to readily perform complicated operations on a communication device, the communication device must be able to provide a function for simplifying complicated operations performed by the operator, while receiving instructions from a management server.

However, the communication device described in JP-A-2004-265174 does not have a mechanism through which the communication device is associated with a management server. Therefore, the communication device fails to alleviate an operational burden on the operator by assigning an operational scenario execution instruction to a particular input function of the communication device, controlling the execution of an operational scenario, acquiring another operational scenario, and the like, in response to instructions from the management server. The operator is not either allowed to inform the management server of the execution status of the communication device, such that the management server manages an operational scenario execution situation of the communication device.

On the other hand, the management system described in JP-A-2001-109686 does not have a mechanism through which the management system interacts with the operator. Therefore, the management system fails to alleviate an operational burden on the operator, when the operator operates the communication device, by executing an operational scenario or updating the operational scenario in response to the operator's instruction.

Thus, a need exists for a communication device which can further alleviate an operational burden on the operator, or a management server for managing the communication device.

### SUMMARY OF THE INVENTION

The present invention provides a communication device which has an input function through which an operator instructs the execution of an operational scenario, and acquires the operational scenario from a management server, executes the operational scenario in response to a simple operational instruction from the operator, and notifies the management server of the result of the execution. The present invention also provides a management server for transmitting an operational scenario and receiving the result of executing the operational scenario.

The present invention also provides a communication device which notifies a management server of an execution status such as the start, end, and processed contents of an operational scenario, and resumes the processing of the operational scenario based on a determination of the management server made on the contents of the notification. The present invention also provides a management server which receives an operational scenario execution status of a communication device, analyses the operational scenario execution status, and transmits the result of a determination to the communication device.

The present invention also provides a communication device which requests a management server for an operational scenario, updates the operational scenario, and notifies an operator and a management server of information on the updated operational scenario.

Specifically, in one aspect, the present invention provides a communication device connected to a management server through a network. The communication device includes a data transfer function for transferring the communication data, a management function for managing the communication device itself, an input function for receiving operations to the communication device by an operator, and an output function for communicating information to the operator from the communication device. The management function includes a function for acquiring a plurality of operational scenarios from a management server connected thereto through the communication network, where each of the operational scenarios describes a plurality of operations executed in the communication device, a function for presenting information on the acquired operational scenarios to the operator using the output unit, a function for responding to the operator entering an operation through the input unit for selecting one of the operational scenarios to execute the selected operational scenario, a function for displaying the result of the execution of the operational scenario through the output function of the communication device, and a function for notifying the management server of the result of the execution of the operational scenario. The management server in turn includes a function for transmitting the plurality of operational scenarios to the communication device, and a function for receiving the result of the execution of the operational scenario from the communication device.

The management function of the communication device further includes a function for notifying the management server of an execution situation of the operational scenario. The management server also includes means for receiving the execution situation of the operational scenario, a function for analyzing the received execution situation for determination, and a function for transmitting the result of the determination to the communication device. The management function of the communication device further includes a function of resuming the previously executed operational scenario based on the received result of the determination.

Further, the management server includes a function for managing information related to the operational scenarios held by the management function of the communication device, and a function for determining an operation scenario which should be newly acquired by the management function. The management function of the communication device further includes a function for updating the operational scenario using the newly acquired operational scenario, and notifying the operator and the management server of information on the updated operational scenario.

With the provision of the foregoing functions, when the operator operates the communication device, the communication device is configured to support the operator in association with the management server.

According to the communication device in the foregoing aspect, by acquiring an operational scenario from the management server and executing the operational scenario, an operator, even if he or she is not an expert, can correctly perform configuration modification operations for the communication device, such as changing a data transfer route for the communication device, shutting down an interface associated with the communication device or shutting down communications, setting a secure communication route between a partner device, with which a client communicates communication data, and the communication device, and the like through simple operations without taking a long time for the operations, and the execution situation can be managed by the management server.

Accordingly, the present invention can provide a communication device and a management server associated therewith which can alleviate an operational burden on an operator, even if he or she is not an expert.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram illustrating the layout of a front panel of a communication device in one embodiment of the present invention;

FIG. 2 is a block diagram illustrating the functional configuration and system configuration of the communication device in one embodiment of the present invention;

FIG. 3 is a flow chart illustrating an operational scenario creation process performed by the communication device in one embodiment of the present invention;

FIG. 4 is a table showing a list of operational scenarios in one embodiment of the present invention;

FIG. 5 is a flow chart illustrating an operational scenario execution process executed by the communication device during the execution of an operational scenario in one embodiment of the present invention;

FIG. 6 shows an operational scenario execution management table for use by the management server in one embodiment of the present invention;

FIG. 7 is a flow chart illustrating an operational scenario execution process during the execution of a delay recovery scenario in one embodiment of the present invention;

FIG. 8 shows an operational scenario execution status management table for use by the management server in one embodiment of the present invention;

FIG. 9 is a flow chart illustrating an operational scenario execution process during the execution of a virus-combating scenario in one embodiment of the present invention;

FIG. 10 is a block diagram illustrating the hardware configuration of a communication device in one embodiment of the present invention; and

FIG. 11 is a flow diagram illustrating a communication sequence during the execution of a secure communication route setting scenario in one embodiment of the present invention.

### DETAILED DESCRIPTION OF THE EMBODIMENTS

In the following, several embodiments of the present invention will be described in detail with reference to the accompanying drawings. The following description is not intended to limit the technical scope of the present invention. In the following description, components having the same function are designated the same reference numerals.

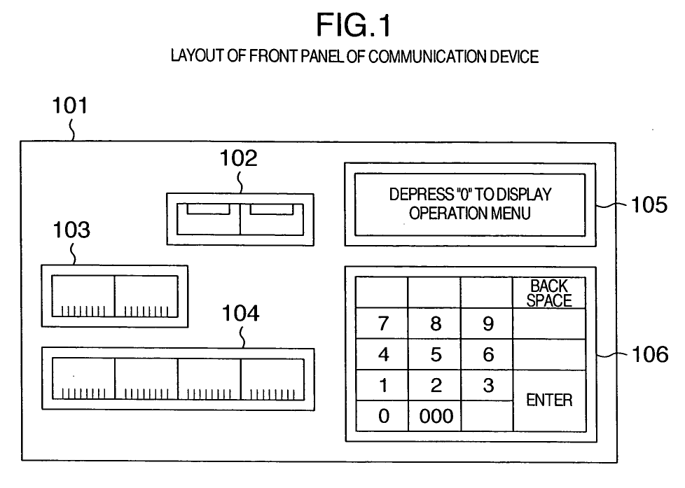

FIG. 1 is a diagram illustrating a front panel of a communication device according to a first embodiment of the present invention.

The communication device 101, which is configured to transfer data between clients and a server connected to the communication device 101 through a wide-area communication network, comprises the illustrated front panel which comprises peripheral device connection interfaces 102 for connection with peripheral devices such as a USB (Universal Serial Bus) connected flash memory or the like; server-side interfaces 103 for connection with external wide-area communication networks; client-side interfaces 104 for connection with clients; a display unit 105 for displaying an operational situation of the communication device and the like; and an input unit 106 for communicating operations performed by the operator to the communication device 101.

The display unit 105 may be a liquid crystal display or the like, and the input unit 106 may be a simple input keyboard such as a numeral key pad. The input unit 106 is only required to simply receive the operator's operation performed thereon, such as operation buttons or the like, and is not limited in form.

The peripheral device connection interface terminals (port/connector) 102 may be interface terminals such as USB, and include two such terminals in FIG. 1. The server-side interface terminals 103 may be an Ethernet terminal such as 10BASE-T or 100BASE-TX, an ATM (Asynchronous Transfer Mode) terminal, an ISDN (Integrated Service Digital Network) S/T point terminal or the like. In FIG. 1, there are two terminals 103. The client-side interface terminal 104 may be an Ethernet terminal, and includes four such terminals in FIG. 1. Ethernet is a tradename of Xerox Corp. in U.S.A.

The front panel may additionally comprise a serial interface terminal for managing the communication device 11, LEDs (Light Emitting Diodes) for indicating a link status of each interface and power on/off, and the like. The aforementioned interface terminals and the like need not be provided in the front panel of the communication device 101, but may be provided instead in a back panel.

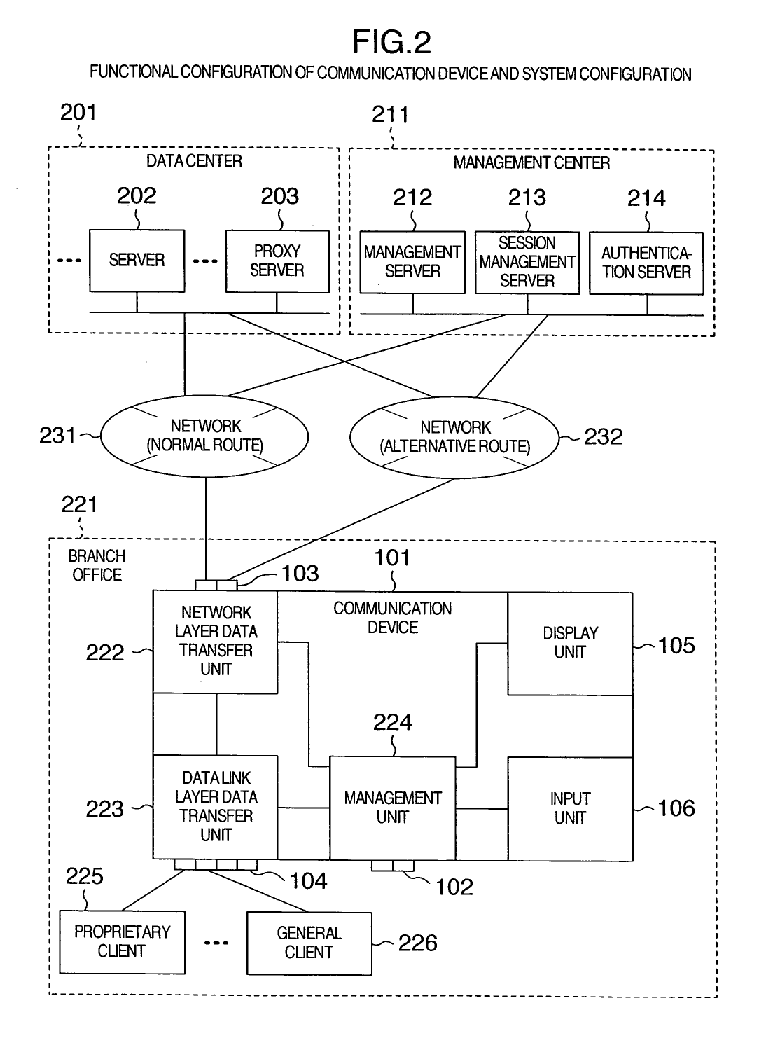

FIG. 2 is a block diagram generally illustrating the functional configuration of the communication device according to the first embodiment, and an entire system to which the communication device is connected.

A data center 201 has installed therein a data server device (hereinafter called the “server”) 202, and a proxy server device (hereinafter called the “proxy server”) 203. The server 202 makes data communications with a proprietary client 225 or a general client 226 in a branch office 221 through the proxy server 203, network 231 or 232, and communication device 101.

The proxy server 203 relays a connection, controls accesses, and forms a secure communication route with the communication device 101 in communications between the proprietary client 225 and general client 226 in the branch office 221 and the server 202. The proxy server 203 may be called a “gateway” in some cases.

The proprietary client 225 refers to a client assigned to limited operations such as an automated teller machine, and is dedicated to a highly important transactions such as a continuous operation for 24 hours throughout a year. The general client 226 refers to a client assigned to general transactions such as a personal computer. Operators in the branch office 221 usually use the general client 226 for performing a plurality of transactions. In the following, assume that a simple designation of the client 226 refers to the general client 226.

A management center 211 have installed therein a management server 212, a session management server device (hereinafter called the “session management server”) 213; and an authentication server device (hereinafter called the “authentication server”) 214. The management server 212 manages the communication device 101 in the branch office 221 through the network 231 or 232.

The session management server 213 manages a communication session in a communication from the proprietary client 225 or client 226 to the server 202, and establishes a connection between the communication device 101 and proxy server 203 in association with the authentication server 214 when the proprietary client 225 or client 226 makes an encrypted secure communication with the server 202. The authentication server 214 authenticates the communication device 101 and proxy server 203 when the proprietary client 225 or client 226 makes a secure communication with the server 202.

The secure communication, used herein, refers to a communication in which information is protected by such functions as data encryption, authentication, falsification detection and the like which make sniffering, spoofing, falsification and the like difficult. The secure communication may be implemented in accordance with any protocol, for example, IPsec (Security Architecture for Internet Protocol), TLS (Transport Layer Security), SSL (Secure Sockets Layer) and the like, or alternatively may be implemented in accordance with another protocol which provides for a secure communication.

The branch office 221 has installed therein the proprietary client 225, client 226, and communication device 101 for connecting these clients to the networks 231, 232.

On communication routes for connecting the server 202 with the proprietary client 225 and client 226, one of the networks 231, 232 serves as a normal route, and the other one serves as an alternative route. Which of the networks 231, 232 should be used for the normal route may differ for each of the proprietary client 225 and client 226 or on a business application basis. In the following description, assume that the network 231 serves as a normal route and the network 232 serves as an alternative route in communications between the client 226 and server 202.

The communication device 101 comprises a network layer data transfer unit 222 for transferring data on a network layer; a data link layer data transfer unit 223 for transferring data on a data link layer; a management unit 224 for managing the communication device 101; and the aforementioned display unit 105 and input unit 106.

The network layer data transfer unit 222 comprises a general router device or a circuit which has similar functions. The data link layer data transfer unit 223 comprises a general layer-2 switching device or a circuit which has similar functions. The management unit 224, display unit 105, and input unit 106 can comprise a general information processing device incorporated in the communication device 101.

The network layer data transfer unit 222 and data link layer data transfer unit 223 are interconnected through a cable within the communication device 101. Similarly, the management unit 224 is connected to the network layer data transfer unit 222, data link layer data transfer unit 223, display unit 105, and input unit 106 through cables within the communication device 101.

The network layer data transfer unit 222 is connected to the networks 231, 232 through the aforementioned server-side interfaces 103. The data link layer data transfer unit 223 is connected to the proprietary client 225 and client 226 through the aforementioned client-side interfaces 104.

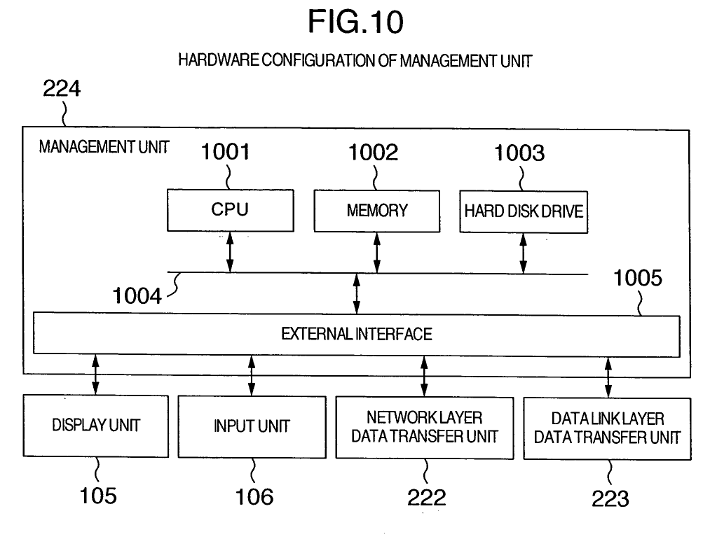

The management unit 224 comprises a hardware configuration illustrated in FIG. 10. Specifically, the management unit 224 comprises a CPU 1001; a memory 1002; a secondary storage device 1003 such as a hard disk drive; an internal signal line 1004 such as a bus; and an external interface 1005 for interfacing with the display unit 105, input unit 106, network layer data transfer unit 222, and data link layer data transfer unit 223.

Each of the network layer data transfer unit 222 and data link layer data transfer unit 223 can also be implemented by a hardware configuration similar to the management unit 224. However, the network layer data transfer unit 222 and data link layer data transfer unit 223 need not comprise the display unit 105, input unit 106, and external interface associated with these units.

The CPU 1001 in each unit loads a program stored in the secondary storage device 1003 into the memory 1002 for execution to implement the functions of the unit. The program may be previously stored in the secondary storage device 1003, or may be introduced into each processing unit as required through a removable storage medium or through carrier waves or digital signals on a communication line.

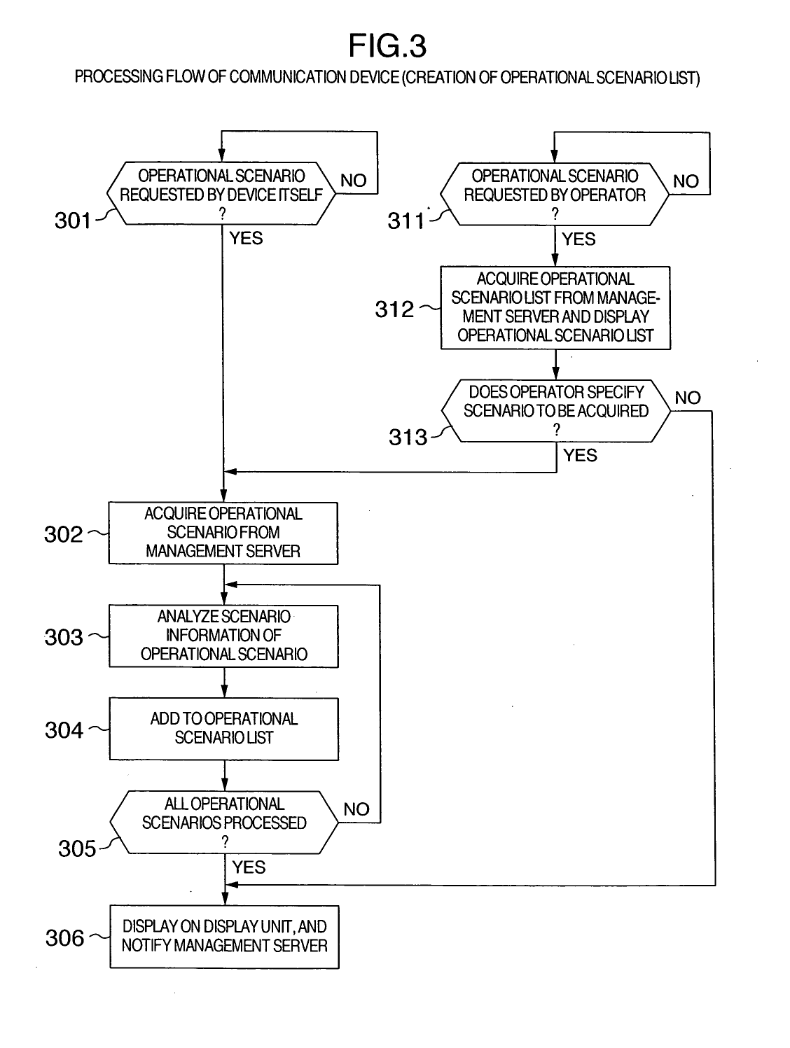

Referring next to FIGS. 3 to 9, description will be made below in connection with the communication device 101 which supports the operator in his or her operations on the communication device 101 itself, using an operational scenario in association with the management server 212.

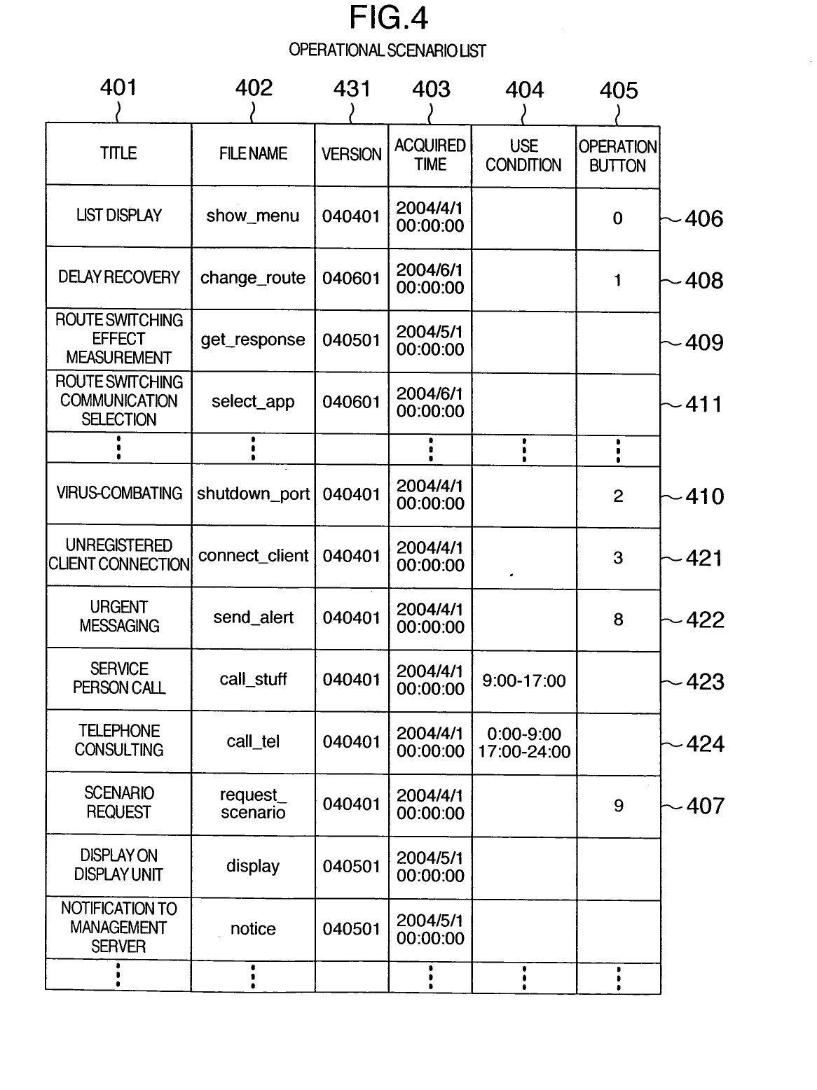

After describing the operational scenario, a process of creating an operational scenario list by the management unit 224 of the communication device 101 will be described with reference to a processing flow illustrated in FIG. 3. FIG. 4 shows the operational scenario list.

The operational scenario describes a flow of a plurality of operations for the communication device 101. The operational scenario may be a file in script form such as shell script, Perl script or the like, or a compiled program in executable form. For the file in script form, an analysis/execution program previously stored in the memory 1002 in the management unit 224 analyses the contents of the operational scenario for execution. For a program in executable form, CPU 1001 of the management unit 224 executes the operational scenario without the need for an additional program.

The operational scenario may take a nested structure. Specifically, operational scenarios may be classified into a type which is directly instructed to run in response to the operator who depresses an associated operation button on the input unit 106, and a type which is called internally during the execution of another operational scenario. A single operational scenario can also be utilized as the type which is directly instructed to run, and as the type which is called from the inside of another operational scenario. Also, a single operational scenario may be called from a plurality of other operational scenarios.

An instruction of executing an operational scenario may be assigned to a single button on the input unit 106 or to a combination of a plurality of buttons. In any case, advantageously, the selection and execution of an operational scenario can be instructed by a simple operation of depressing a button, thereby eliminating command inputs, which have been conventionally required to the operator. It should be noted that an internally called operational scenario need not be assigned to an operation button.

The management unit 224 manages operational scenarios using an operational scenario list as shown in FIG. 4. The operational scenario list includes a title 401 representative of operation contents defined by an operational scenario; a file name 402 of the operational scenario; version information 431 of the operational scenario; a time 403 at which the operational scenario was acquired from the management server 212; an operational scenario use condition 404 such as a time zone; a number 405 of an operation button which is assigned an operational scenario execution instruction; and the like. Likewise, the management server 212 manages the same operational scenario list in correspondence to an identifier (ID) 601 of the communication device 101. An operational scenario which has a number described in the operation button column 405 belongs to the type which is directly instructed to run by the operator depressing the operation button, whereas an operational scenario which is blank in the operation button column 405 belongs to the type which is internally called in another operational scenario.

Referring now to FIG. 3, at step 301, the management unit 224 starts processing from step 302 onward in accordance with a period previously set thereto, and the like.

At step 302, the management server 212 has previously held and managed operational scenario list information corresponded to the identifier (ID) 601 of the communication device 101, and determines an operational scenario which should be newly acquired by the management unit 224 or which should be updated. The management unit 224 acquires a new operational scenario or an operational scenario to be updated from the management server 212 for storage in an operational scenario storage folder (a region in a memory included in the management unit 224).

The management unit 224 may acquire a plurality of operational scenarios. An operational scenario to be acquired may be a complete operational scenario or a differential file which describes a portion to be updated. The operational scenario is updated on a scenario-by-scenario basis. An operational scenario to be acquired may be any of the type directly instructed to run and the type called from the interior of another operational scenario.

The operational scenario may be acquired in any communication form by accessing the management server 212 from the management unit 224 for acquisition or by distributing the operational scenario from the management server 212 to the management unit 224. A sequence of processing associated with the acquisition of an operational scenario may be performed in accordance with any of such protocols as FTP (File Transfer Protocol), HTTP (HyperText Transfer Protocol), SMTP (Simple Mail Transfer Protocol).

At step 303, the management unit 224 analyzes scenario information on one of operational scenarios acquired at step 302. The scenario information includes an indication as to whether the associated operational scenario is differential or not; the title 401 of the operational scenario; file name 402 of the operational scenario; version information 431; operational scenario use condition 404 such as a time zone; number 405 of an operation button which is assigned an instruction of executing the operational scenario; and the like. The scenario information is described in a header or the like of an operational scenario file. The management unit 224 updates the intended operational scenario when it is a differential file.

At step 304, the management unit 224, upon acquisition of a complete operational scenario, adds the information analyzed at step 303 and the acquired time 403 of the operational scenario from the management server 212 to the operational scenario list as shown in FIG. 4. When the management unit 224 acquired a differential file of an operational scenario to update the operational scenario, the management unit 224 updates the acquisition time 403 from the management server 212, version information 431, operational scenario use condition 404 such as a time zone, and the like.

At step 305, the management unit 224 returns to step 303 if there is any operational scenario, within the operational scenarios acquired from the management server 212, which has not been subjected to the analysis on the scenario information. When the management unit 224 has analyzed all of the acquired operational scenarios, the management unit 224 proceeds to step 306.

At step 306, the management unit 224 extracts information from the updated operational scenario list, and displays a list including from the operational scenario title 401 to operation button 405 on the display unit 105. The display unit 105 displays information on operational scenarios assigned to operation buttons on the input unit 106. If the operational scenario information cannot displayed on the display unit 105 at one time, the operational scenario information may be scrolled to display the entirety. The operational scenario information may be notified from the management unit 224 to the operator in combination with an electronic mail in addition to the display on the display unit 105, as described above. When an electronic mail is relied on for the notification, the operational scenario information may be notified from the management server 212. Also, the operational scenario list may be displayed on the display unit 105 by the operator who operates on the input unit 106, such as “depression of operation button 0,” as indicated by 406.

The management unit 224 further notifies the management server 212 of the updated operational scenario list together with the identifier (ID) 601 of the communication device 101 for notifying the management server 212 of the latest status of operational scenarios possessed thereby.

At step 311, the management unit 224 requests the management server 212 to acquire operational scenarios, triggered by an instruction from the operator, such as “depress operation button 9” 407, rather than executing the creation of an operational scenario list, triggered by an instruction from the communication device 101 itself, as is the case with the aforementioned step 301.

At step 312, the management unit 224 acquires a list of available operational scenarios from the management server 212 through a communication technique similar to that used at step 302, and displays the acquired list on the display unit 105. The operational scenario list acquired from the management server 212 refers to the list which includes from the operational scenario title to the operation button number. This list also includes an item “not acquired” indicated by “0.”

At step 313, when the operator specifies the number of an operational scenario to be acquired by depressing an associated button on the input unit 106, the management unit 224 goes to step 302 to perform the processing described above. The operational scenario to be acquired is either an operational scenario corresponding to the number specified by the operator, or an operational scenario called internally by the operational scenario.

When the operator selects to “acquire no operational scenario” by depressing the button “0,” the management unit 224 goes to the aforementioned step 306.

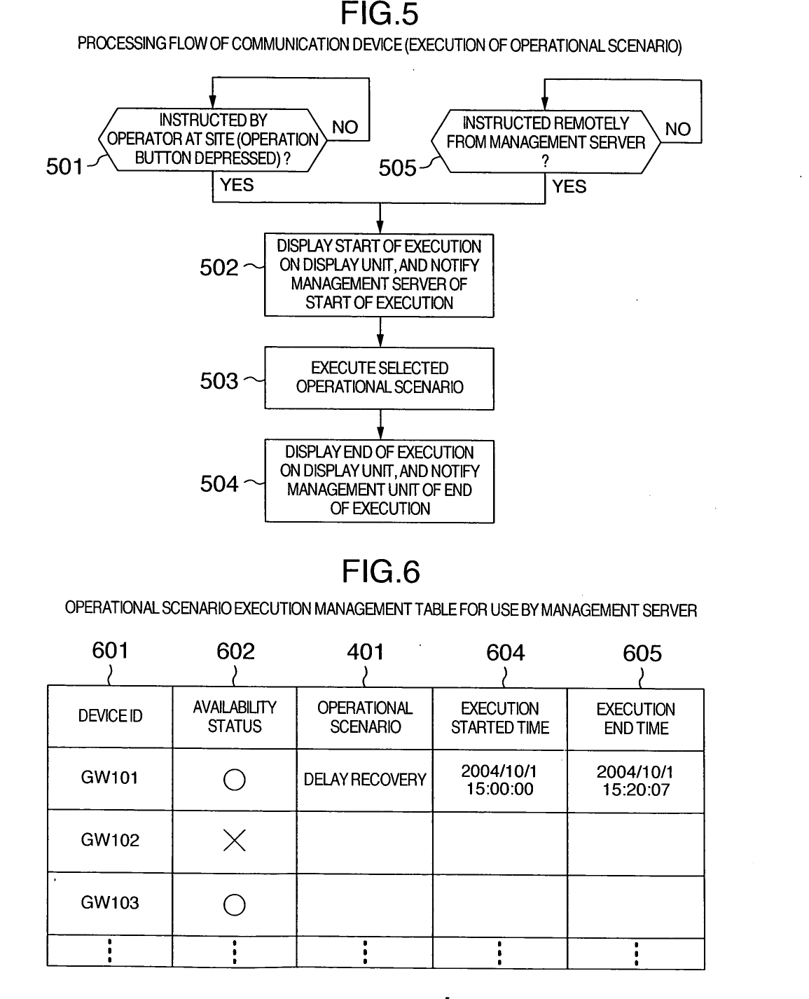

Referring next to a flow chart of FIG. 5, description will be made on a process through which the management unit 224 of the communication device 101 executes an operational scenario. FIG. 6 shows how the management server 212 manages the execution of the operational scenario in FIG. 5.

At step 501, the management unit 224 performs an operational scenario execution process from step 502 onward when the operator selects an operational scenario 401 through an input operation such as depressing a button on the input unit 106.

At step 502, the management unit 224 notifies the operator and management server 212 of the start of the execution of the operational scenario. For notifying the operator, the management unit 224 may display a message such as “DELAY RECOVERY SCENARIO HAS BEEN STARTED” on the display unit 105 using the title of 401 of the operational scenario. In this event, an audible message may be used in combination with the displayed notification.

The management unit 224 also notifies the management server 212 of the identifier (ID) 601 of the communication device 101, the title 401 of the operational scenario, the file name 402, the execution started time 604, and the like. This notification may be made in accordance with any of protocols such as HTTP (HyperText Transfer Protocol), SMTP (Simple Mail Transfer Protocol) and the like.

The execution of the operational scenario can be started at a specified time as well as triggered by the operator depressing a button on the input unit 106.

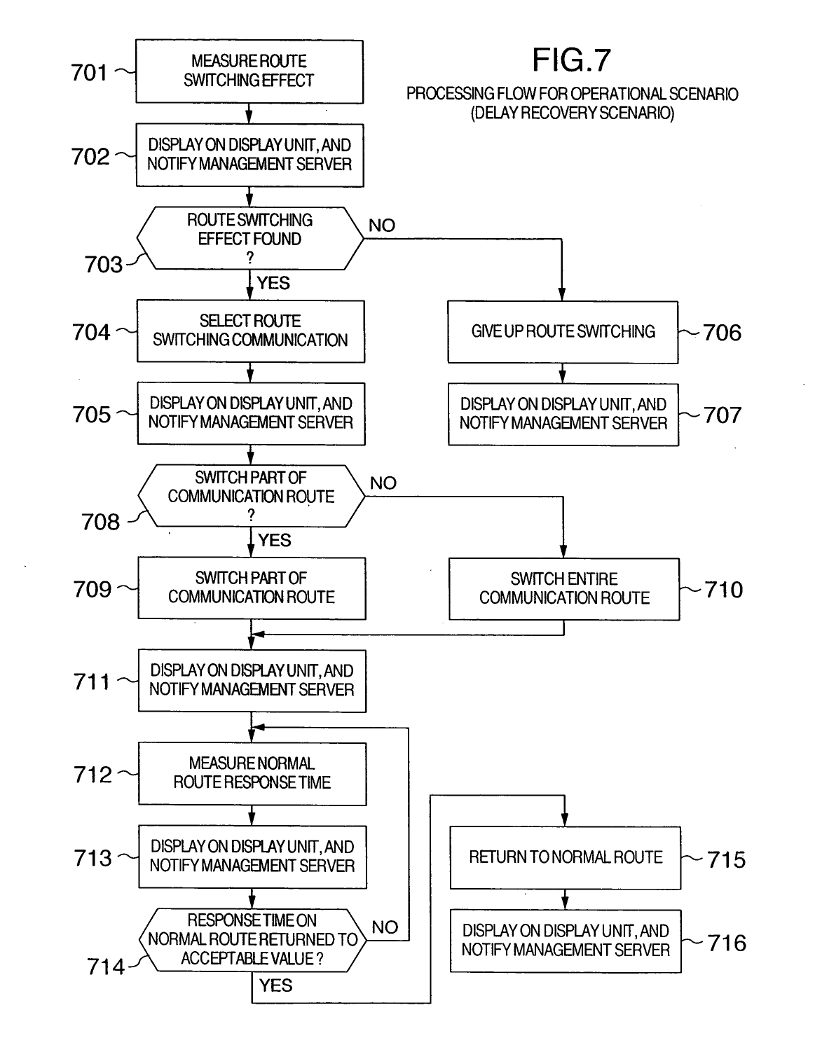

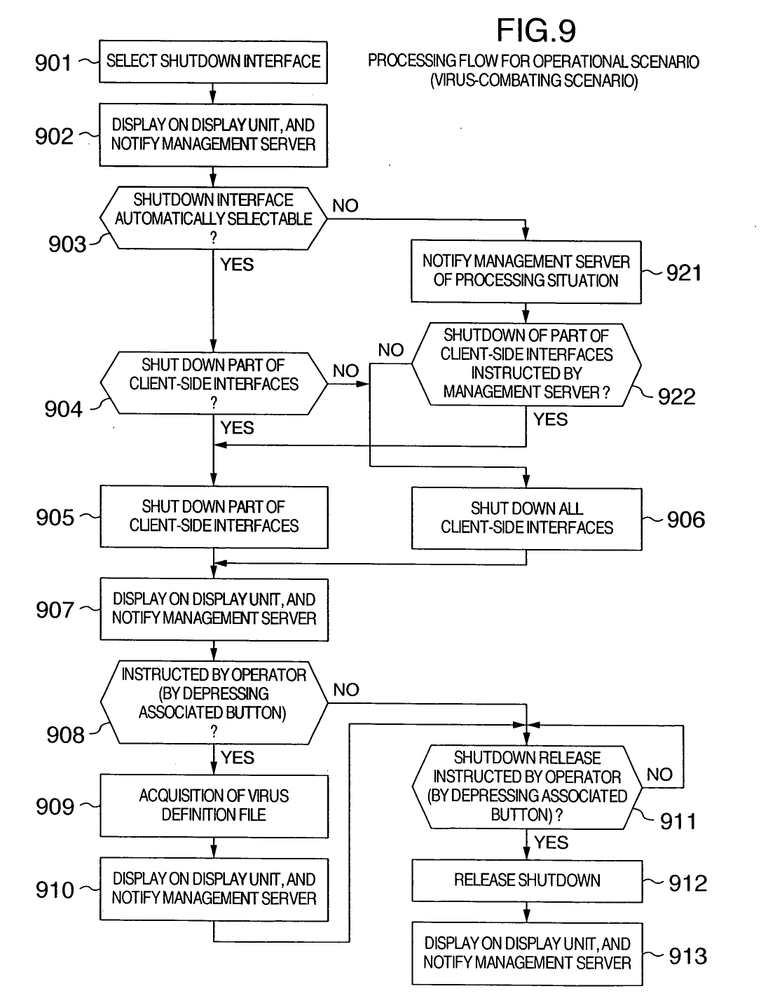

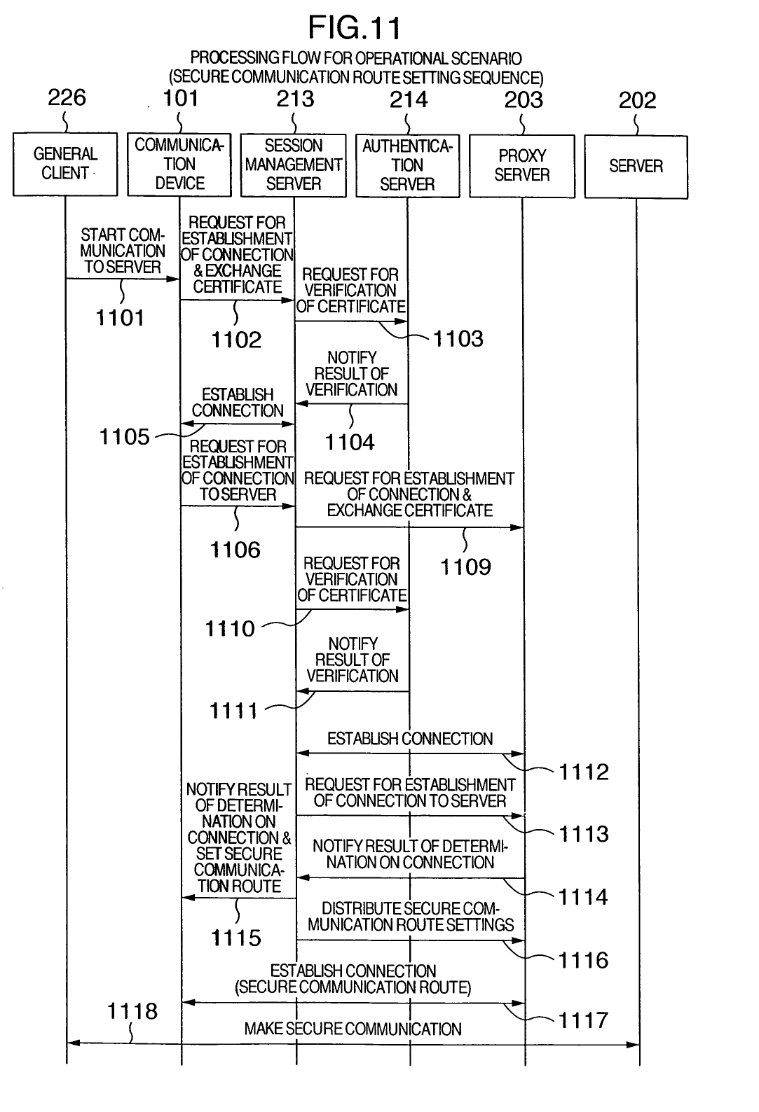

At step 503, the management unit 224 executes the operational scenario selected by the operator at step 501. Specific examples will be given below of the execution of operational scenarios with reference to FIG. 7 in connection of a delay recovery, to FIG. 9 in connection with a virus-combating, and to FIG. 11 in connection with a setting of a secure communication route, respectively.

At step 504, the management unit 224 notifies the operator and management server 212 of the end of the execution of the operational scenario. For notifying the operator, the management unit 224 may display a message such as “DELAY RECOVERY SCENARIO HAS BEEN COMPLETED” on the display unit 501 using the title 401 of the operational scenario. In this event, an audible message may be used in combination with the displayed notification. The management unit 224 also notifies the management server 212 of the identifier (ID) 601 of the communication device 101, the title 401 of the operational scenario, the file name 402, the execution end time 605, and the like.

As shown in step 505, the management unit 224 can execute an operational scenario as triggered by an operation instruction from the management server 212 instead of executing an operational scenario as triggered by the operator operating on the input unit 106, as does at the aforementioned step 501. The operation instruction may be issued from the management server 212 to the management unit 224 in accordance with any of protocols such as telnet, ssh (Secure SHell) and the like.

As shown in FIG. 6, the management server additionally manages availability status 602 of the communication device 101. This management can be made by periodically transmitting the “alive” notice from the communication device 101 to the management server 212 or by querying the status from the management server 212 to the communication device 101. Such notification and query may be implemented in accordance with any of protocols such as ICMP (Internet Control Message Protocol), SNMP (Simple Network Management Protocol), HTTP (HyperText Transfer Protocol), SMTP (Simple Mail Transfer Protocol) and the like.

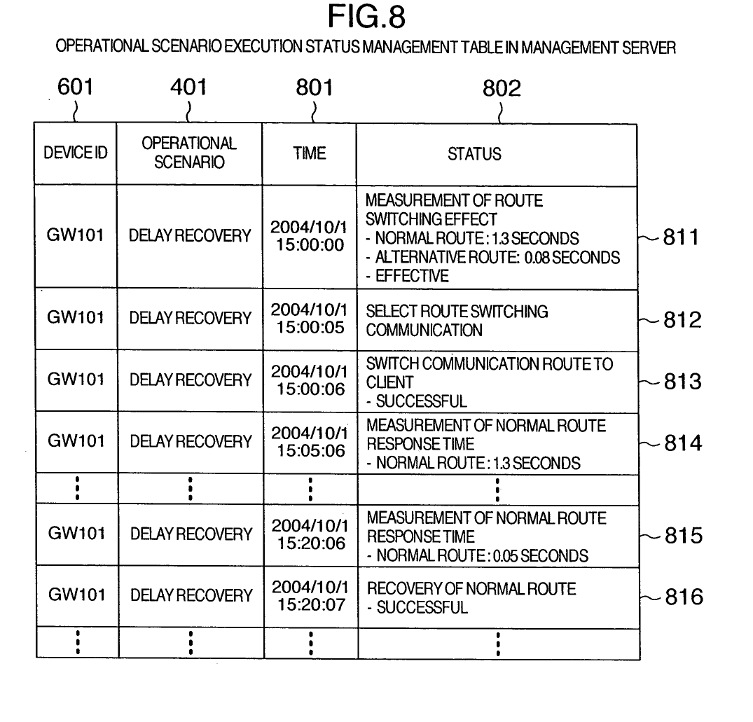

Next, referring to the processing flow of FIG. 7, description will be made on the execution of a delay recovery scenario 408 as an example of executing an operational scenario, corresponding to the processing at step 503 in FIG. 5. Also, FIG. 8 shows how the management server 212 manages the execution status of the operational scenario 408 in FIG. 7.

The delay recovery scenario 408 is called on the assumption that the operator operates the communication device 101 to switch to an alternative communication route in order to solve a delay in communication which occurs for some cause or which is felt by the operator when the operator is communicating from the client 226 to the server 202 through a normal communication route to carry out transactions.

At step 701, the management unit 224 measures a response time on each of the normal route and alternative route in order to confirm the effect of switching from the normal route to the alternative route. The delay is expected to be solved by switching from the normal route to the alternative route if the delay in communication is caused by the normal route, whereas it is contemplated that even the switching of the communication route will not eliminate the delay if the delay is caused by the processing in the server 202. The route is switched when the delay is expected to be solved by switching to the alternative route.

In order to confirm the effect of the route switching, the management unit 224 measures an ICMP echo (ping) response time (network level response time) on routes from the management unit 224 to the server 202, to which a communication is to be made, or to a hub or the like to which the server 202 is directly connected. The response time is measured on both the normal route and alternative route. If the response time on the normal route is longer than a normal value on the normal route by a threshold or more, and if the response time on the alternative route is shorter than the response time on the normal route by a threshold or more, the management unit 224 determines that the switching to the alternative route is effective. Otherwise, the management unit 224 determines that the switching to the alternative route is not effective.

In addition to the estimation on the effect of the route switching, the identification of a spot which causes the delay would be effective for managing the communication device 101 in the management server 212. For identifying a delay causing spot, the management unit 224 measures a response time corresponding to a processing protocol of the server 202 (application level response time) by measuring a response time of an HTTP packet to the server 202 when the server 202 is an HTTP server, or by measuring a response time of an SMTP packet to the server 202 when the server 202 is an SMTP server. The application level response time can be regarded as the sum of a delay time on the network 231 or 232 and the processing time required by the server 202.

The management unit 224 determines that the delay is caused by the server 202 when there is not a difference equal to or larger than the threshold between the measured network level response time and the normal value on the normal route or on both the normal route and alternative route, and when the application level response time is longer than the normal value by the threshold or more.

The processing at step 701 is executed by calling a route switching effect measuring scenario 409 from the delay recovery scenario 408.

At step 702, the management unit 224 displays the result of the measurement at step 701 on the display unit 105, and also notifies the management server 212 of the same. When a delay causing spot has been identified, the management unit 224 also displays the identified spot on the display unit 105, and notifies the management server 212 of the identified spot. The management unit 224 may display “DELAY IS EXPECTED TO BE RECOVERED BY SWITCHING THE ROUTE” OR “DELAY IS NOT EXPECTED TO BE RECOVERED EVEN IF THE ROUTE IS SWITCHED” on the display unit 105. The management unit 224 also notifies the management server 212 of the identifier (ID) 601 of the communication device 101, the title 401 of the operational scenario, the execution time 801, the execution status 802, and the like (row 811 in FIG. 8).

The management unit 224 proceeds to step 704 when it determines at step 703, from the measurement made at step 701, that the switching to the alternative route is effective. Otherwise, the management unit 224 proceeds to step 706 when it determines that the switching to the alternative route is not effective.

At step 704, the management unit 224 selects a job communication for switching the communication route to the alternative route. When the normal route is expected to be recovered from the delay by reducing the amount of communication data based on the response time measured at step 701, part of the communication route is switched to the alternative route to use both the alternative route and normal route. The communication route is completely switched to the alternative route when the response time on the normal route is determined extremely long by the above-mentioned threshold test.

The processing at step 704 is executed by calling a route switching communication selection scenario 411 from the delay recovery scenario 408, in a manner similar to the processing at step 701. At each of the following steps, an internal scenario corresponding to each step is also called for execution in a similar manner.

At step 705, the management unit 224 displays the result of the selection made at step 704 on the display unit 105, and also notifies the management server 212 of the same. The management unit 224 may display “PART OF COMMUNICATION ROUTE IS SWITCHED” on the display unit 105. The management unit 224 also notifies the management server 212 of the identifier (ID) 601 of the communication device 101, the title 401 of the operational scenario, the execution time 801, the execution status 802, and the like (row 812 in FIG. 8).

The management unit 224 determines at step 706 that the communication route should not be switched on the assumption that the switching to the alternative route is not effective.

At step 707, the management unit 224 displays the result of the determination at step 706 on the display unit 105, and also notifies the management server 212 of the same. The management unit 224 may display “ROUTE IS NOT SWITCHED BECAUSE DELAY IS NOT CAUSED BY NETWORK” on the display unit 105. The management unit 224 also notifies the management server 212 of the identifier (ID) 601 of the communication device 101, the title 401 of the operational scenario, the execution time 801, the execution status 802, and the like.

The management unit 224 proceeds to step 709 when it determines at step 708 that part of the communication route should be switched to the alternative route. Alternatively, the management unit 224 proceeds to step 710 when it determines that the entire communication route should be switched to the alternative route.

At step 709, the management unit 224 connects to the network layer data transfer unit 222 to update a configuration file of the network layer data transfer unit 222 to switch part of the communication route. The communication route may be divided on an operation-by-operation basis, or may be divided into a portion associated with the proprietary client 225 and a portion associated with the client 226. A communication route associated with the client 226 used by the operator may be switched to a corresponding alternative route.

At step 710, the management unit 224 connects to the network layer data transfer unit 222 to update the configuration file of the network layer data transfer unit 222 to switch the entire communication route.

At step 711, the management unit 224 displays the switching performed step 709 or step 710 on the display unit 105, and also notifies the management server 212 of the same. The management unit 224 may display “COMMUNICATION ROUTE TO CLIENT n HAS BEEN SWITCHED TO ALTERNATIVE ROUTE” or “COMMUNICATION ROUTE HAS BEEN FULLY SWITCHED TO ALTERNATIVE ROUTE” on the display unit 105. The management unit 224 also notifies the management server 212 of the identifier (ID) 601 of the communication device 101, the title 401 of the operational scenario, the execution time 801, the execution status 802, and the like (row 813 in FIG. 8). Even when the management unit 224 fails the route switching operation at step 709 or step 710, the management unit 224 displays details on the failure on the display 105, and notifies the management server 212 of the failure in a similar manner.

At step 712, the management unit 224 measures the response time on the normal route in a similar approach to that used at step 701 in order to ascertain to which degree the normal route has been recovered from the delay.

At step 713, the management unit 224 displays the result of the measurement made at step 712 on the display unit 105, and also notifies the management server 212 of the same. The management unit 224 may display “RESPONSE TIME ON NORMAL ROUTE IS 1.3 SECONDS” on the display unit 105. The management unit 224 also notifies the management server 212 of the identifier (ID) 601 of the communication device 101, the title 401 of the operational scenario, the execution time 801, the execution status 802, and the like (row 814 in FIG. 8).

The management unit 224 proceeds to step 715 when it determines at step 714 that the response time on the normal route has returned to an acceptable level by the above-mentioned threshold test. Conversely, when the management unit 224 determines that the response time on the normal route is still excessively long, the management unit 224 repeats steps 712, 713 in a certain time (row 815 in FIG. 8).

At step 715, the management unit 224 connects to the network layer data transfer unit 222 to return the configuration file of the network layer data transfer unit 222 to the original one before the switching of the communication route, and switches again the communication route to the normal route.

At step 716, the management unit 224 displays the recovery to the normal route at step 715 on the display unit 105, and also notifies the management server 212 of the same. The management unit 224 may display “COMMUNICATION ROUTE HAS SWITCHED AGAIN TO NORMAL ROUTE” on the display unit 105. The management unit 224 also notifies the management server 212 of the identifier (ID) 601 of the communication device 101, the title 401 of the operational scenario, the execution time 801, the execution status 802, and the like (row 816 in FIG. 8). Even when the management unit 224 fails the route recovery operation at step 715, the management unit 224 displays details on the failure on the display 105, and notifies the management server 212 of the failure in a similar manner.

Referring next to a processing flow of FIG. 9, description will be made on the execution of a virus-combating scenario 410 as another example of executing an operational scenario. The processing at steps 901 to 922 in FIG. 9 is equivalent to the processing at step 503 in FIG. 5.

The virus-combating scenario 408 is called on the assumption that due to the infection of the client 226 used by the operator by a computer virus for some cause or a determination made by the operator that the client 226 has been infected by the virus, the operator operates the communication device 101 to shut down the communication interfaces and acquire a virus definition file for disinfection from the management server 212 with the intention to localize the damage given by the computer virus in the client 226 which suffers from the damage or in the branch office 221 and to disinfect the virus. In this virus-combating scenario 408, a computer virus is detected by dedicated virus-combating software in the client 226, while the communication device 101 supports the localization of damages caused by the virus, and the acquisition of the latest virus definition file for disinfection.

At step 901, upon receipt of a virus-combating scenario execution instruction from the operator, the management unit 224 determines whether all client-side interfaces should be shut down, including a connection interface associated with the proprietary client 225, in order to localize the damages, or a connection interface associated with the client 226 should be shut down while permitting communications with the proprietary client 225. For this purpose, the management unit 224 queries the proprietary client 225 to check whether the proprietary client 225 is infected by a computer virus.

At step 902, the management unit 224 displays the result of the check made at step 901, and also notifies the management server 212 of the same. The management unit 224 may display “PROPRIETARY CLIENT 225 IS CHECKED FOR INFECTION BY VIRUS” on the display unit 105. The management unit 212 also notifies the management server 212 of the identifier (ID) 601 of the communication device 101, the title 401 of the operational scenario, the execution time 801, the execution status 802, and the like.

At step 903, the management unit 224 determines that certain client-side interface 104 to be shut down can be automatically selected when the proprietary client 225 has a function of responding to a query about its virus infected state, or when the management unit 224 has previously determined that all the client-side interfaces 104 are shut down when the client 226 is infected by a virus, and proceeds to step 904. When the proprietary client 225 does not have the function of responding to a query about its virus infected state, so that the management unit 224 cannot determine whether all the client-side interfaces should be shut down, including the connection interface associated with the proprietary client 225, or the connection interface associated with the client 226 should be shut down while permitting communications with the proprietary client 225, the management server 212 makes this determination. In this event, the management unit 224 proceeds to step 921.

At step 904, upon receipt of a response from the proprietary client 225 stating that it is not infected by any virus, the management unit 224 determines that the interface associated with the client 226 should be shut down, and proceeds to step 905. Conversely, when the management unit 224 receives a response from the proprietary client 225 stating that it is infected by a virus, or when the management unit 224 has previously determined that all the client-side interfaces should be shut down when the client 226 is infected by a virus, the management unit 224 proceeds to step 906.

At step 921, management unit 224 sends a log to the management server 212 for notifying the management unit 212 of a processing situation at step 901. Upon receipt of the notification, the management server 212 analyzes the log of the management unit 224 and then investigates whether or not the proprietary client 225 is infected by a virus. The investigation as to whether or not the proprietary client 225 is infected by a virus may be made by a direct investigation method which involves connecting to the proprietary client 225 from the management server 212 to analyze the log, or by an indirect investigation method which involves querying a dedicated management server for managing the state of the proprietary client 225 as to the state of the proprietary client 225.

At step 922, when the management server 212 determines from the result of the investigation at step 921 that the proprietary client 225 is not infected by a virus, the management server 212 determines to shut down the interface associated with the client 226, and instructs the management unit 224 to proceed to step 905. When the management server 212 determines that the proprietary client 225 is infected by a virus, the management server 212 determines that all the client-side interfaces 104 should be shut down, and instructs the management unit 224 to proceed to step 906.

At step 905, the management unit 224 connects to the data link layer data transfer unit 223 to update the configuration file of the data link layer data transfer unit 223, and shut down one of the client-side interfaces 104 to which the client 225 is connected. Alternatively, the management unit 224 may connect to the network layer data transfer unit 222 to update the configuration file of the network layer data transfer unit 222, and shut down communications from one of the client-side interfaces 104 to which the client 225 is connected. Shutting down an interface, used herein, means that an interface terminal (called a port or a connector as the case may be) is made electrically inactive, while shutting down communications means access control and filtering of communications performed by software-based processing.

At step 906, for shutting down all the client-side interfaces 104, the management unit 224 connects to the data link layer data transfer unit 223 to update the configuration file of the data link layer data transfer unit 223, and shuts down all the client-side interfaces 104. Alternatively, the management unit 224 may connect to the network layer data transfer unit 222 to update the configuration file of the network layer data transfer unit 222, and shut down communications from all the client-side interfaces 104.

At step 907, the management unit 224 displays the result of the shutdown operation at step 905 or 906 on the display unit 105, and also notifies the management server 212 of the same. The management unit 224 may display “CONNECTION INTERFACE TO THE CLIENT IS SHUT DOWN” OR “ALL CLIENT-SIDE INTERFACES ARE SHUT DOWN” on the display unit 105. The management unit 224 also notifies the management server 212 of the identifier (ID) 601 of the communication device 101, the title 401 of the operational scenario, the execution time 801, and execution status 802, and the like.

The management unit 224 may further display “INSERT USB MEMORY AND DEPRESS “1” FOR ACQUIRING THE LATEST VIRUS DEFINITION FILE. DEPRESS “2” IF THE FILE IS NOT REQUIRED” on the display unit 105 in order to prompt the operator to acquire the virus definition file.

Further, the management unit 224 may display “DEPRESS “3” FOR RELEASING INTERFACE SHUTDOWN” on the display unit 105 in order to notify the operator of an interface shutdown releasing method.

At step 908, the management unit 224 proceeds to step 909 when the operator depresses the button “1” on the input unit 106 to indicate the acquisition of the virus definition file. The management unit 224 proceeds to step 911 when the operator depresses the button “2” on the input unit 106 to indicate that it is not necessary to acquire the virus definition file.

At step 909, the management unit 224 connects to the management server 212 through the server-side interface 103 to acquire the latest virus definition file. The management unit 224 stores the acquired virus definition file in an USB memory inserted into the peripheral device connection interface 102 by the operator. The acquisition of the virus definition file may be carried out in accordance with any of such protocols as FTP (File Transfer Protocol), HTTP (HyperText Transfer Protocol), SMTP (Simple Mail Transfer Protocol), and the like. The operator utilizes the latest virus definition file stored in the USB memory to confirm the virus infected state of the client 226 and disinfect the virus.

At step 910, the management unit 224 displays the acquisition of the virus definition file at step 909 on the display unit 105, and also notifies the management server 212 of the same. The management may display “VIRUS DEFINITION FILE IS DOWNLOADED INTO USB MEMORY” on the display unit 105. The management unit 224 also notifies the management server 212 of the identifier (ID) 601 of the communication device 101, the title 401 of the operational scenario, the execution time 801, the execution status 802, and the like. Even in the event of a failure in acquiring the virus definition file due to the absence of a USB memory in the peripheral device connection interface 102, or the like, the management unit 224 likewise displays the failure on the display unit 105 and also notifies the management 212 of the same.

At step 911, when the operator depresses the button “3” on the input unit 106 to instruct the management unit 224 to release the client-side interface 104 from the shutdown after disinfection, the management unit 224 proceeds to step 912.

At step 912, for releasing the client-side interface 104 from the shutdown, the management unit 224 connects to the data link layer data transfer unit 223 to return the configuration file of the data link layer data transfer unit to the state before the shutdown, thus releasing the client-side interface 104 from the communication shutdown. Alternatively, the management unit 224 connects to the network layer data transfer unit 222 to return the configuration file of the network layer data transfer unit to the state before the shutdown, thus releasing the client-side interface 104 from the communication shutdown.

At step 913, the management unit 224 displays the release from the shutdown at step 912 on the display unit 105, and also notifies the management server 212 of the same. The management unit 224 may display “CLIENT-SIDE INTERFACE IS RELEASED FROM SHUTDOWN” on the display unit 105. The management unit 224 also notifies the management server 212 of the identifier (ID) 601 of the communication device 101, the title 401 of the operational scenario, the execution time 801, the execution status 802, and the like.

Next, referring to a communication sequence shown in FIG. 11, description will be made on the execution of a secure communication route setting scenario by the communication device 101 in association with the session management server 213, authentication server 214, and proxy server 203.

This secure communication route setting scenario establishes a secure communication route by forming a virtual private network (VPN) between the communication device 101 and proxy server 202 in order to protect communications between the client 226 and server 202. The formation of the secure communication route is performed in accordance with such a protocol as IPsec, TLS, SSL or the like, as mentioned above.

A secure communication route may be formed between the client 226 and server 202, but when there are a plurality of clients 226 and servers 202, the communication device 101 and proxy server 203 may form a secure communication route instead of the clients 226 and servers 202 to eliminate the need for management and configuration operations for an electric certificate and the like, which would be otherwise required for forming a secure communication route at each of the clients 226 and each of the servers 202, and also eliminate the need for modifying communications which have been made between the clients 226 and servers 202. Assume in this configuration that the security is ensured for communications between the communication device 101 and client 226 and within the data center 201 with the aid of a dedicated communication route, a firewall or the like.

In the setting of a secure communication route, the communication device 101 or proxy server 203 itself may authenticate a communication partner, but the session management server 213 and authentication server 214 may intensively authenticate the communication device 101 and proxy server 203, as described below at associated steps, so that the communication device 101 and proxy server 203 need not authenticate their respective communication partners, i.e., they need not manage the electronic certificate for their respective communication partners, thereby reducing a burden involved therein. The session management server 213 may communicate with the communication device 101 and proxy server 203 in accordance with a protocol, for example, SIP (Session Initiation Protocol) or the like.

The management unit 224 of the communication device 101 starts the execution of a previously set operational scenario in response to the operator depressing a button on the input unit for issuing an instruction to start a secure communication route setting process from step 1102 onward for a proxy server 203 or one of a plurality of proxy servers 203 described in the operational scenario. The secure communication route setting process may be started in response to an instruction from the management server 212. Alternatively, the management unit 224 may start the secure communication route setting process for a proxy server 203 of a server 202 which is requested for a communication by the client 226 in response to the start of a communication (step 1101) from the proprietary client 225 or client 226 to the server 202. The management unit 224 displays, for example, “SECURE COMMUNICATION ROUTE SETTING IS STARTED” on the display unit 105 in order to notify the operator of the start of the secure communication route setting process, and also notifies the management server 212 of the same. The notification to the operator may be combined with an audible message.

At step 1102, the management unit 224 of the communication device 101 requests the session management server 213 to establish a connection, and exchanges the electronic certificate. In the communication device 101, the electronic certificate may be directly stored in the hard disk drive 1103 of the management unit 224, or may be stored in an USB memory, an IC card or the like connected to the peripheral device connection interface 102 of the management unit 224. The same is applied to the session management server 213 as well. When there is no electronic certificate of the communication device 101, the management unit 224 displays that the electronic certificate is not present on the display unit 105, and also notifies the management unit 212 of the lack of the electronic certificate.

At step 1103, the session management server 213 requests the authentication server 214 to verify the electronic certificate of the communication device 101 received from the management unit 224 of the communication device 101.

At step 1104, the authentication server 214 verifies the electronic certificate of the communication device 101 received at step 1103, and notifies the session management server 213 of the result of the verification.

At step 1105, a connection is established between the communication device 101 and session management server 213 when the electronic certificate is confirmed to be valid as a result of the verification at step 1104. Conversely, if the electronic certificate is determined to be invalid, the management unit 224 displays that the electronic certificate is invalid on the display unit 105, and also notifies the management server 212 of this fact.

At step 1106, the management unit 224 of the communication device 101 requests the session management server 213 to establish a connection from the communication device 101 or client 226 to the proxy server 203 or server 202.

At step 1109, the session management server 213 requests the proxy server 203 to establish a connection, and exchanges the electronic certificate. The electronic certificate is stored in the proxy server 203 in a manner similar to that described in connection with step 1102 at which the electronic certificate is stored in the communication device 101.

At step 1110, the session management server 213 requests the authentication server 214 to verify the electronic certificate received from the proxy server 203.

At step 1111, the authentication server 214 verifies the electronic certificate of the proxy server 203 received at step 1110, and notifies the session management server 213 of the result of the verification.

At step 1112, a connection is established between the session management server 213 and proxy server 203 when the electronic certificate is confirmed to be valid as a result of the verification at step 1111.

At step 1113, the session management server 213 forwards the connection establishment request from the communication device 101 or client 226 to the proxy server 203 or server 202, received at step 1106, to the proxy server 203.

At step 1114, the proxy server 203 determines whether or not the proxy server 203 or server 202 can be accessed from the communication device 101 or client 226 based on attribute information on the communication device 101 or client 226, use permission information on the server 202 or a business application, whether or not the connection establishment request is made through the session management server 213, and the like, and notifies the session management server 213 of the result of the determination.

At step 1115, the session management server 213 transfers the result of the determination regarding the connection from the communication device 101 or client 226 to the proxy server 203 or server 202, received at step 1114, to the management unit 224 of the communication device 101. When the result of the determination shows “connection permitted,” the session management server 213 distributes information on settings for a secure communication route to the proxy server 203 to the management unit 224. The secure communication route setting information includes setting parameters associated with a communication encryption scheme when the communication device 101 and proxy server 203 form a secure communication route, and is implemented by SA (Security Association) when he secure communication route setting is performed in accordance with IPsec.

At step 1116, the session management server 213 distributes the information on settings for a secure communication route to the management unit 224 of the communication device 101 to the proxy server 203, when the result of the determination shows “connection permitted” in a manner similar to step 1115.

At step 1117, the management unit 224 of the communication device 101 establishes a secure communication route connection with proxy server 203 without intervention of the session management server 213 or authentication server 214, utilizing the secure communication route setting information received at step 1115, when it is notified at step 1115 that a connection can be made from the communication device 101 or client 226 to the proxy server 203 or server 202. The management unit 224 displays the establishment of the secure communication route connection on the display unit 105, and also notifies the management server 212 of the same.

When the electronic certificate is invalid as a result of the verification at step 1111, or when the result of the determination at step 1114 shows “connection not permitted,” the session management server 213 notifies the management unit 224 of the communication device 101 to that effect. Upon receipt of the notification, the management unit 224 displays “CONNECTION NOT PERMITTED” on the display unit 105, and also notifies the management server 212 of the same.

The management unit 224 returns to step 1102 or 1106 to repeat the processing in a similar manner to the above when the operational scenario describes more proxy servers 203 or servers 202 for which a secure communication route should be formed.

At step 1118, the client 226 and server 202 make secure communications through the secure communication route formed between the communication device 101 and proxy server 203. The communication device 101 may apply the secure communication route to all clients 226, or may apply it only to some of the clients 226, or may apply it only to some communications.

Other operational scenarios include, for example, an urgent messaging scenario 422, an unregistered client connection scenario 421, and the like.

The urgent messaging scenario 422 is provided on the assumption that the operator requests an expert in the management center 211 for supports when the communication quality degrades or the communication device 101 and/or client 226 fail for some cause or when the operator senses a degradation of the communication quality such as a delay and/or a failure in the communication device 101 and/or client 226.

In the urgent messaging scenario 422, in response to an associated operation button on the input unit 106 depressed by the operator, the management unit 224 starts a service person calling scenario 432 to request the management server 212 for a mission of a service person to the site, or starts a telephone consulting scenario 424 to request the management server 212 for a telephone call from an expert in the management center in accordance with a time zone in which the operator depresses the operation button. In this event, the management unit 224 sends a communication log of the network layer data transfer unit 222 and data link layer data transfer unit 223 and/or a processing log of the management unit 224 to the management server 212. With these logs, the management server 212 can ascertain the situation of the communication device 101 in detail and take appropriate measures thereto.

The unregistered client connection scenario 421 is provided on the assumption that a user such as a service person attempts to connect an unregistered client to the communication device for a maintenance operation or the like of the proprietary client 225, client 226, or communication device 101 in a situation in which a connection to the communication device 101 is generally permitted only to registered clients. In the unregistered client connection scenario 421, the management unit 224 sets one of the client-side interfaces 104 of the communication device 101 as a temporary work interface, authenticates a user, and permits an unregistered client to be connected to the temporary work interface.

The authentication of the user is performed by entering a password from the input device 106, or authenticating an electronic certificate stored in a USB memory, an IC card or the like connected to the peripheral device connection interface 102. Upon confirmation of an authorized user through the authentication, the management unit 224 releases a shutdown of the temporary work interface, which is usually shut down, to permit a connection of an unregistered client thereto. However, the management unit 224 records a time at which the unregistered client was connected to the temporal work interface, all contents of communications to/from the unregistered client in a log or the like, and sequentially notifies the management unit 212 of such information. Upon detection of a fraudulent operation on the connected unregistered client, the management unit 224 immediately shuts down the temporal work interface, and notifies the management server 212 of the detected fraudulent operation and the shutdown of the temporal work interface.

As described above, the communication device according to the foregoing embodiment provides the following features and function.

Specifically, in the foregoing embodiment, the management unit 224 of the communication device 101 comprises the input unit 106 for the operator to instruct the execution of an operational scenario, acquires the operational scenario from the management server 212, assigns an operational scenario execution instruction key to the input unit 106, executes the operational scenario in response to a simple operation of the operator indicative of an instruction, and notifies the management server 212 of the result of executing the operational scenario. The management server 212 transmits the operational scenario to the communication device 101, and receives the result of executing the operational scenario.

Further, the management unit 224 of the communication device 101 notifies the management server 212 of the execution status such as the start, end, and processing contents of the operational scenario, and resumes the processing of the operational scenario based on the result of a determination made by the management server 212 on the notified contents. The management server 212 receives an operational scenario execution situation of the communication device 101, analyses the operational scenario execution situation, and transmits the result of the determination to the communication device 101.

Further, the management server 212 manages information related to operational scenarios possessed by the management unit 224 of the communication device 101 to determine an operational scenario which should be acquired by the management unit 224. The management unit 224 of the communication device 101 requests the management server 212 for an operational scenario, updates the requested operational scenario, and sends information on the updated operational scenario to the operator and management server 212.

With the foregoing components operated in association, even an operator other than experts can correctly perform configuration modification operations, such as changing a data transfer route for the communication device 101, shutting down an interface associated with the communication device 101 or shutting down communications, setting a secure communication route between the communication device 101 and proxy server 203, and the like through simple operations without taking a long time for the operations, so that the status of the operation can be sequentially managed by the management server 212.

It should be further understood by those skilled in the art that although the foregoing description has been made on embodiments of the invention, the invention is not limited thereto and various changes and modifications may be made without departing from the spirit of the invention and the scope of the appended claims.

1. A communication system having a client, a communication device for relaying communication data transmitted from and received by the client, a management server, and a communication network for interconnecting the client, the communication device, and the management server, wherein:
the communication device comprises:
a data transfer unit for transferring the communication data;
a management unit for managing the communication device itself;
an input unit for receiving an operation to the communication device by an operator; and
an output unit for communicating information to the operator,
the management unit is configured to:
capture a plurality of operational scenarios from the management server, each of the operational scenarios describing a plurality of operations executed in the communication device;
present information on the acquired operational scenarios to the operator using the output unit;
respond to an operation entered by the operator through the input unit for selecting and executing one of the operational scenarios for executing the selected operational scenario;
output the result of executing the operational scenario on the output device; and
notify the management server of the result of the execution of the operational scenario, and the management server is configured to:
transmit the plurality of operational scenarios to the communication device; and
receive the result of the execution of the operational scenario from the communication device.

2. A communication system according to claim 1, wherein:
the management unit of the communication device notifies the management server of an execution situation during the execution of the operational scenario under a predetermined condition,
the management server is configured to:
receive the execution situation of the operational scenario;
analyze the received execution situation for determination;
transmit the result of the determination to the communication device, and
the management unit of the communication device resumes the previously executed operational scenario based on the received result of the determination.

3. A communication system according to claim 1, wherein:
the management server is configured to:
manage information related to the operational scenarios held by the management unit of the communication device; and
determine an operational scenario which should be newly acquired by the management unit, and
the management unit of the communication device is configured to:
update the operational scenarios held therein using the newly acquired operational scenario;
present information on the updated operational scenario to the operator; and
notify the management server of the information on the updated operational scenario.

4. A communication system according to claim 1, wherein:
the management unit of the communication device executes a configuration modification process for the communication device in accordance with the operation of the operator for selecting and executing the operational scenario.

5. A communication system according to claim 4, wherein:
the configuration modification process for the communication device executed by the management unit of the communication device includes a process for switching the data transfer route for the communication device.

6. A communication system according to claim 4, wherein:
the configuration modification process for the communication device executed by the management unit of the communication device includes a process of shutting down a communication interface or shutting down a communication of the data transfer unit.

7. A communication system according to claim 4, wherein:
the configuration modification process for the communication device executed by the management unit of the communication device includes a process of forming a secure communication route for use by the client for transmitting and receiving the communication data.

8. A communication device for relaying communication data transmitted from and received by a client through a communication network, the communication device comprising:
a data transfer unit for transferring the communication data;
a management unit for managing the communication device itself;
an input unit for receiving an operation to the communication device by an operator; and
an output unit for communicating information to the operator,
wherein the management unit is configured to:
acquire a plurality of operational scenarios from a management server connected thereto through the communication network, each of the operational scenarios describing a plurality of operations executed in the communication device;
present information on the acquired operational scenarios to the operator using the output unit;
respond to an operation entered by the operator through the input unit for selecting and executing one of the operational scenarios for executing the selected operational scenario;
output the result of executing the operational scenario on the output device; and
notify the management server of the result of the execution of the operational scenario.

9. A communication device according to claim 8, wherein the management unit is configured to:
notify the management server of an execution situation during the execution of the operational scenario under a predetermined condition;
receive the result of a determination based on the execution situation by the management server; and
resume the previously executed operational scenario based on the received result of the determination.

10. A communication device according to claim 8, wherein the management unit is configured to:
acquire an operational scenario determined by the management server to be newly acquired by the communication device;
update the operational scenarios held therein using the acquired operational scenario;
present information on the updated operational scenario to the operator; and
notify the management server of the information on the updated operational scenario.

11. A communication device according to claim 8, wherein:
the management unit executes a configuration modification process for the communication device in accordance with the operation of the operator for selecting and executing the operational scenario.

12. A communication device according to claim 11, wherein:
the configuration modification process for the communication device executed by the management unit includes a process for switching the data transfer route for the communication device.

13. A communication device according to claim 11, wherein:
the configuration modification process for the communication device executed by the management unit includes a process of shutting down a communication interface or shutting down a communication of the data transfer unit.

14. A communication device according to claim 11, wherein:
the configuration modification process for the communication device executed by the management unit includes a process of forming a secure communication route for use by the client for transmitting and receiving the communication data.
